(19) United States
(12) Patent Application Publication
(10) Pub. No.: US 2012/0083569 A1
(43) Pub. Date: Apr. 5, 2012

(54) Polymerizable Compounds, Curable Compositions And Methods

(75) Inventor: Albert Geipert, Biebesheim (DE)

(73) Assignee: KUNSTSTOFF-UND FARBEN-GESELLSCHAFT MBH, Biebesheim (DE)

(21) Appl. No.: 13/322,920

(22) PCT Filed: Jun. 8, 2010
(86) PCT No.: PCT/EP2010/003456

§ 371 Date: Nov. 28, 2011

(30) Foreign Application Priority Data
Jun. 10, 2009 (DE) 10 2009 024 452.2

(51) Int. Cl. C09D 133/12; C09D 175/04; C09J 175/04; C08L 75/04

(52) U.S. Cl. 524/560; 525/454; 525/123; 524/590

(57) ABSTRACT

The present invention relates to polymerizable compounds, comprising 5-50% by weight polyurethane, having at least one soft segment and 30-95% by weight alkylmethacrylate having 1-6 carbon atoms in the alkyl radical, wherein the polyurethane has a molecular weight in the range from 5,000-200,000 daltons, curable compositions comprising the inventive polymerizable compounds, and coatings and impact-resistant objects made from the curable compositions.

The invention relates to polymerizable compounds and curable compositions, which cure to form bondings, molded bodies and coatings having high impact resistance.

Methyl methacrylate resins are widely used as coatings for industrial flooring, roadway markings, etc. These systems are customarily produced by dissolving copolymers of methacrylic acid esters such as methyl methacrylate, butyl methacrylate and copolymers of acrylic acid esters such as butyl acrylate or ethylhexyl acrylate in monomers having the same base, more particularly, methyl methacrylate. Coating masses of this type are processed alone or together with filler materials and are cured using redox systems.

To achieve a certain degree of impact resistance, it is known to use copolymers having a PVC/vinyl acetate base or graft copolymers having a methyl methacrylate/butyl acrylate/styrene base.

Combinations with urethane methacrylates have also been described (DE 102006 039849). With respect to impact resistance, however, these systems are unsatisfactory and therefore unsuitable for single-layer coatings.

From DE 10 2005 055793 it is known to further improve PMMA molding compound that has already been modified in terms of impact resistance using nuclear, shell and impact resistance modifiers, by mixing said compound with thermoplastic polyurethane (TPU). More particularly, this document describes that by mixing 70 wt % impact resistance modified PMMA with 30 wt % TPU, the low-temperature impact resistance can be improved. In contrast, by mixing TPU with PMMA standard molding compound that has not been modified in terms of impact resistance, no improvement of impact resistance is achieved.

Polymerizable compounds for producing highly impact resistant cast plates on the basis of cross-linked polyurethane/polymethacrylate systems containing 3-8 wt % polyurethane are known from DE 69120843. According to this teaching, first a polyurethane network is formed, after which the alkyl methacrylate is polymerized. Interestingly, this patent specifies that in this mixed system, the impact resistance passes through an optimum as a function of the polyurethane content. For instance, 7 wt % polyurethane results in an impact resistance according to Charpy testing of 68 kJ/m², whereas 4 wt % polyurethane results in a value of 45 kJ/m², and 10 wt % results in a value of 43 kJ/m².

In the field of casting compounds, various approaches exist for producing impact-resistant objects having a high modulus of elasticity by combining polyurethane and polymethacrylate, in which generally interpenetrating networks of polyurethane and polymethacrylate are desired; however, in general, at least one of the two polymer species forms a network.

To achieve this, urethane formation and vinyl polymerization are carried out simultaneously, as is the case with the rapid polymerization according to DE 26 29 457, for example. With this rapidly running polymerization to highly cross-linked objects, however, the formulation is limited to a vinyl monomer concentration ranging from 15-60 wt % due to the high heat of reaction.

As a rule, however, polymerization is carried out in 2 stages. In a first stage, under the influence of the urethane catalyst, for example, dibutyltin dilaurate, a polyurethane network is produced, after which vinyl polymerization is carried out at elevated temperature (DE 20 03 365).

A similar process is described in EP 0272975. In this case as well, first a polyurethane network is produced, and the methacrylate monomers are then polymerized in this network. For example, according to example 1, polymerization is carried out first for 4 hours at 50° C., then for 2 hours at 75° C. and finally for 2 hours at 95° C.

As is described in DE 20 03 365, simultaneous vinyl polymerization and polyurethane network formation result in a macroscopic and/or strong phase separation between the obtained polyurethane network and the vinyl polymer, with disadvantageous effects on the mechanical and optical properties. Moreover, the significant increase in viscosity during the course of polymerization is very difficult to control.

In particular, coating compounds that are ordinarily cured at room temperature using a redox system cannot be produced from the traditional casting compounds.

Thus the goal is a compound which can be polymerized via redox polymerization, and which can be cured to form highly impact-resistant, homogeneous polyurethane, polymethacrylate composite systems.

A further problem can be considered that of providing a polymerizable compound that can be used as a coating compound, adhesive and/or casting compound. The cured compounds should have excellent impact resistance, wear resistance, tear resistance, vibration resistance and tensile strength. Further, the elasticity modulus should be variable across a wide range, so that objects having a very high or relatively low elasticity modulus can be obtained. These properties should be maintained for an extended period of time. The cured compounds should exhibit high permanent elasticity and relatively high temperature stability. Furthermore, the cured compounds should be highly resistant to chemicals.

A further problem addressed by the present invention is that of providing polymerizable compounds having the stated properties, which can be produced and processed particularly easily. More particularly, the compounds should be polymerizable under the widest range of conditions, with the processing time (pot life) being adjustable to the widest range of requirements. For example, it should be possible to expose the polymerizable compounds to the weather after only a short time. Additionally, the polymerizable compounds should be processable even by relatively poorly qualified people. Furthermore, the polymerizable compounds should be producible in a cost-effective manner.

These and other problems that are not explicitly identified here, but can be easily derived or deduced from the context discussed in the introductory section, are solved by a polymerizable compound having all the features of patent claim 1. Expedient modifications of the polymerizable compound according to the invention are protected under the claims that are dependent upon claim 1.

Accordingly, the subject matter of the present invention is a polymerizable compound, containing

A 5-50 wt % polyurethane having at least one soft segment and

B 30-95 wt % alkyl methacrylate having 1-6 carbon atoms in the alkyl group, which is characterized in that the polyurethane has a molecular weight ranging from 5,000-200,000 daltons.

Thus a polymerizable compound is provided in a non-obvious manner, which can be used as a coating compound, an adhesive and/or a casting compound. The cured compounds exhibit excellent impact resistance, wear resistance, tear resistance, vibration resistance and tensile strength. These properties are retained over an extended period of time. The cured compounds have a high permanent elasticity and a relatively high temperature stability. Additionally, the cured compounds exhibit surprisingly good mechanical properties, more particularly, excellent impact resistance, even at very low temperatures. The cured compounds further have a high resistance to chemicals and a low tendency to form stress cracks. Furthermore, the polymerized compounds exhibit a high stability to weather. Additionally, the elasticity modulus can be varied over a wide range, and therefore, objects having a very high or relatively low modulus of elasticity can be obtained.

The polymerizable compounds can be used as an adhesive on a multitude of substrates, wherein the adhesive is particularly well suited for joining the widest range of materials.

The present invention further provides polymerizable compounds having the stated properties, which can be produced and processed with particular ease. More particularly, the compounds can be polymerized under the widest range of conditions, wherein the processing time (pot life) can be adjusted to the widest range of requirements. For example, the polymerizable compounds can be exposed to the weather after only a short time. Further, the compounds can be cured even at temperatures of −20° C. Additionally, the polymerizable compounds can also be processed even by relatively poorly qualified persons. Furthermore, the polymerizable compounds can be cost-effectively produced.

According to a particular aspect of the present invention, a polymerizable compound, containing

A 5-30 wt % polyurethane having at least one soft segment with a glass transition temperature of <20° C.,

B 70-95 wt % alkyl methacrylate having 1-6 carbon atoms in the alkyl group,

C 0-20 wt % one or more monomers that can be copolymerized with the alkyl methacrylates listed under B,

which is characterized in that the polyurethane has a molecular weight ranging from 5,000-200,000 daltons and which is further characterized in that it contains vinyl polymers having a molecular weight ranging from 5,000-5,000,000 daltons only in ratios of <5 wt %, preferably <1 wt %, and particularly preferably not at all, is particularly well suited for use as a casting or coating compound.

Particularly well suited are polymerizable compounds which also contain 0.03-3 wt % polymerization regulators having at least 2 thiol groups in the molecule. Suitable polymerization regulators include thioglycolic acid esters of polyvalent alcohols such as ethylene glycol dithioglycolate, and pentaerythritol tetrathioglycolate, for example.

Preferred polymerizable compounds further contain cross-linking agents such as alkanediol di(meth)acrylate or propanetriol tri(meth)acrylate in ratios of 0.03-5 wt % and preferably in ratios of 0.1-1 wt %.

Of particular interest is a polymerizable compound which contains 0.1-5 wt % a solvent-free, low-viscosity isocyanate prepolymer having a functionality ranging from 2-3.5.

The compounds preferably contain a redox system for carrying out radical polymerization, and particularly preferable is a redox system which consists of at least one tertiary aromatic amine and at least one peroxy compound, preferably benzoyl peroxide.

Particularly suitable are polymerizable compounds that contain 0.1-5 wt % paraffin. Paraffins having a melting range of 40-60° C., particularly having a melting range of 52-54° C. are preferred.

The polymerizable compounds according to the invention are suitable for producing impact-resistant objects. More particularly, the paraffin-containing compounds are usable as coating compounds.

### Polyurethane A

An essential constituent of the polymerizable compound according to the invention is a content of 5 to 50 wt %, particularly 5 to 30 wt %, preferably 6 to 25 wt %, preferably 8 to 20 wt %, particularly preferably 10 to 17 wt % polyurethane A, dissolved in monomer B and, if used, monomer C.

Polyurethanes are polymers in which repeating units are linked by urethane groups —NH—CO—O—. Polyurethanes are ordinarily formed by addition polymerization of dihydric or polyhydric alcohols to divalent or polyvalent isocyanates (Römpp Chemie Lexikon, 9^{th} Edition, page 3575, or Kunststoffe [Plastics] 80, 1193). Technically significant polyurethanes are produced, for example, from polyester diols and polyether diols, and from toluidine diisocyanate and/or hexamethylene diisocyanate.

Polyurethanes that are suitable for use in the polymerizable compounds according to the invention have at least one soft segment. The soft segment serves to improve the impact resistance of the compound that is obtainable by polymerization of the monomer B. Preferably, the soft segment has a glass transition temperature Tg of less than 20° C., preferably <0° C. and particularly preferably <−20° C. The glass transition temperature can be determined according to customary methods, for example, by dynamic/mechanical analysis (DMA) or by dynamic differential calorimetry (DSC), for example, according to DIN 53765, ISO 11357-2 (heating rate 10 K/min) or DIN 53445, ASTM D-5279. In this case, the value data are understood as approximations, since polyurethanes having a high glass transition temperature do not lead to an improvement in impact resistance. Particularly suitable are, for example, polyurethanes on the basis of polyester diols and/or polyether diols and aliphatic and/or aromatic diisocyanates.

Examples of the starting components to be used for producing the polyurethanes to be used according to the invention are described, for example, in High Polymers, Vol. XVI, “Polyurethanes, Chemistry and Technology”, by Saunders-Frisch, Interscience Publishers, New York, London, Volume I, 1962, pages 32-42 and pages 44-54, and Volume II, 1964, pages 5-6 and 198-199, and in the Kunststoff-Handbuch [Plastics Handbook], Volume VII, Vieweg-Hochtlen, Carl-Hanser Verlag, Munich, 1966, for example, on pages 45 to 71. Suitable longer-chain diols having at least 2 terminal hydroxyl groups in the molecule are preferably polyesters, polyethers, polyacetals, polycarbonates, polyesteramides, and polyamides, wherein polyesters and polyethers are preferred.

Suitable polyesters containing hydroxyl groups include conversion products of dihydric alcohols with divalent carboxylic acids, for example. In place of the free polycarboxylic acids, corresponding polycarboxylic acid anhydrides or corresponding polycarboxylic acid esters of lower alcohols or mixtures thereof can also be used to produce the polyesters. The polycarboxylic acids can be aliphatic, cycloaliphatic, aromatic and/or heterocyclic in nature and, if applicable, can be substituted by halogen atoms, for example, and/or unsaturated. Examples of these include: succinic acid, adipic acid, suberic acid, azelaic acid, sebacic acid, phthalic acid, isophthalic acid, terephthalic acid, phthalic anhydride, tetrahydrophthalic anhydride, hexahydrophthalic anhydride, tetrachlorophthalic anhydride, endomethylene tetrahydrophthalic anhydride, glutaric anhydride, maleic acid, maleic anhydride, fumaric acid, terephthalic acid dimethylester, terephthalic acid-bis-glycolester, and 1,12-dodecanedicarboxylic acid. Polyvalent alcohols include, for example, ethylene glycol, propylene glycol-(1,2) and -(1,3), butylene glycol-(1,4)- and -(2,3), hexanediol-(1,6), octanediol-(1,8), neopentyl glycol, cyclohexanedimethanol (1,4-bis-hydroxymethylcyclohexane), 2-methyl-1,3-propanediol, along with diethylene glycol, triethylene glycol, tetraethylene glycol, polyethylene glycols, dipropylene glycol, polypropylene glycols, dibutylene glycol and polybutylene glycols. Additionally, polyesters from lactones, for example, ε-caprolactone or hydroxycarboxylic acids, for example, ω-hydroxycaproic acid can be used.

Possible polyethers containing two hydroxyl groups also include those of the known type that are produced, for example, by polymerizing epoxides such as ethylene oxide, propylene oxide, butylene oxide, styrene oxide or epichlorohydrin with itself, for example, in the presence of BF₃, or by addition of these epoxides, optionally in a mixture or successively, to starting components containing reactive hydrogen atoms such as alcohols or amines, for example, water, ethylene glycol, propylene glycol-(1,3) or -(1,2), 4,4′-dihydroxy-diphenylpropane or aniline. Particularly preferred are polyethers that contain predominantly primary OH groups (up to 90 wt %, referred to all OH groups present in the polyether).

Of the listed polyol components for producing the polyurethane, particularly preferred are polyesters having high ratios, preferably at least 50 wt %, particularly preferably at least 80 wt %, of aliphatic or cycloaliphatic diol- and/or dicarboxylic acid repeating units.

Preferred divalent or polyvalent isocyanates include, particularly, aliphatic and cycloaliphatic isocyanates that have a particularly high resistance to light, such as hexamethylene diisocyanate (HDI), isophorone diisocyanate (IPDI), 4,4′-diisocyanato dicyclohexylmethane (H12MDI) and 1,4-cyclohexyl diisocyanate (CHDI). Aromatic isocyanates having at least two isocyanate groups may also be used, wherein toluene diisocyanate (TDI), diphenylmethane diisocyanate (MDI), naphthylene diisocyanate (NDI) and polymeric diphenylmethane diisocyanate (PMDI) are listed as examples. Aromatic isocyanates are characterized by particularly high reactivity, and are therefore ordinarily preferred if light resistance is of subordinate importance for the respective application.

Preferred polyurethanes are composed of an adipic acid hexanediol polyester and toluene diisocyanate, for example. Polyurethanes having a high polyester content are also preferred over polyurethanes having a high polyether content.

Polyurethane A has a molecular weight ranging from 5,000 to 200,000 daltons, particularly 5,000 to 150,000 daltons, preferably ranging from 8,000 to 100,000 daltons, particularly preferably 30,000 to 150,000 and most particularly preferably 30,000 to 100,000 daltons. In this case, the molecular weight relates to the individual molecules, so that the polymerizable compound has at least 5 wt % polyurethane molecules having a molecular weight within the stated range. The mixture can also contain polyurethane ratios that lie outside of the range specified in claim 1. However, polyurethanes having a low molecular weight contribute only insignificantly to improving impact resistance, whereas a high proportion of polyurethanes having a molecular weight greater than 200,000 daltons can result in a radical increase in viscosity, thereby decreasing the processability of the available polymerizable compound. The ratio of polyurethanes having a molecular weight within the stated range can be determined from the molecular weight distribution of the polyurethanes used. Analysis particularly by means of gel-permeation chromatography (GPC) can be performed for this purpose, wherein measurement can be carried out, for example, at 25° C. The numerical average of the molecular weight Mₙ of the polyurethanes used preferably ranges from 5,000 to 200,000 daltons, particularly preferably 10,000 to 150,000 daltons, and especially preferably ranges from 30,000 to 100,000 daltons. The weight average of the molecular weight M_{w} of the polyurethanes used preferably ranges from 10,000 to 250,000 daltons, particularly preferably 20,000 to 200,000 daltons and especially preferably ranges from 30,000 to 150,000 daltons. The polydispersion index M_{w}/Mₙ of preferable polyurethanes can particularly range from 1.0 to 10, particularly preferably from 1.2 to 5.

According to a preferred aspect of the present invention, the polyurethane can have a viscosity ranging from 5,000 mPa·s to 200,000 mPa·s, particularly preferably from 20,000 mPa·s to 60,000 mPa·s, measured according to DIN EN ISO 3219/A3 at 23° C. as a 30 percent by weight solution in ethyl acetate.

Preferred polyurethanes contain free hydroxyl terminal groups, preferably having a functionality of approximately 2. Preferably, the functionality ranges from 1.8 to 3.0, particularly preferably 1.9 to 2.5, referred to the hydroxyl groups. The functionality refers to the average number of hydroxyl groups per polyurethane molecule, and can be determined according to DIN 53240. Examples include Impranil C and Impranil CHW from Bayer, and Irostic 6514-007N.

To the extent that the polyurethanes are miscible, i.e., they will produce a homogeneous melt mixture or a homogeneous, clear solution in monomers B and C, mixtures of polyurethanes A can also be used. However, polymerizable compounds that contain only one type of polyurethane are preferred.

Because, as is known, most high polymers are incompatible with one another even in solution, polymerizable compounds are preferred which contain no dissolved polymers other than polyurethane A. The polymerizable compound preferably contains vinyl polymers, such as PMMA, having a molecular weight of 5,000-5,000,000 daltons only in ratios of <20 wt %, particularly <10 wt %, preferably <5 wt %, particularly preferably <1 wt %. Particularly preferred are polymerizable compounds containing the high-molecular polyurethane A as the sole dissolved polymer component.

Therefore, the rheological properties of the polymerizable compound are determined by the content of polyurethane A, the molecular weight thereof, and the interaction of the polymer with monomers B and C.

Preferably, the molecular weight and the content of polyurethane A are selected such that a polymerizable compound having a viscosity of 50 to 10,000 cP, particularly preferably 100 to 5,000 cP and most particularly preferably 150 to 1,500 cP results. In this manner, surprising advantages can be achieved using polymerizable compounds, the viscosity of which enables bubble-free processing.

### Alkyl Methacrylate Monomer B

The alkyl methacrylates B are methacrylic acid esters of C1-C6 alkanols. Examples of these are methyl-, butyl- and cyclohexyl methacrylate. MMA (methyl methacrylate) is particularly preferred. The ratio of these monomers to the polymerizable compound is ordinarily 30 to 95 wt %, preferably 50 to 95 wt %, particularly 70 to 95 wt %, especially 80 to 92 wt %.

### Monomer C

As additional monomer C, which can be contained in the polymerizable compound in ratios of preferably 0-65 wt %, particularly preferably 0-45 wt %, and especially preferably 0 to 20 wt %, monomers that can be radically copolymerized with MMA are specified. These include, for example, C1-C8 alkyl esters of acrylic acids such as butyl acrylate, 2-ethylhexyl acrylate, alkyl esters of methacrylic acid, different from those listed under B, or functional monomers such as hydroxyethyl methacrylate. The term functional monomers refers particularly to compounds which, in addition to an unsaturated C—C double bond, have at least one additional reactive group. These include, particularly, monomers having two or more ethylenically unsaturated C—C double bonds, monomers having hydroxyl groups, or monomers having acid groups.

According to a particular aspect of the present invention, the polymerizable compound can preferably contain 0.05 to 40 wt %, particularly 0.1 to 20 wt %, and particularly preferably 1 to 15 wt % C1-C8 alkyl esters of the acrylic acid.

Of particular significance are polymerization cross-linking agents, including such cross-linking agents as acrylic acid esters and methacrylic acid esters of polyvalent alcohols. These include particularly (meth)acrylates derived from unsaturated alcohols, such as allyl(meth)acrylate and vinyl(meth)acrylate, and (meth)acrylates derived from diols or polyvalent alcohols, for example, glycol di(meth)acrylates, such as ethylene glycol di(meth)acrylate, diethylene glycol di(meth)acrylate, trimethylene glycol di(meth)acrylate, tetra- and polyethylene glycol di(meth)acrylate, 1,3-butanediol di(meth)acrylate, 1,4-butanediol di(meth)acrylate, 1,6-hexanediol di(meth)acrylate, glycerol di(meth)acrylate and diurethane dimethacrylate; (meth)acrylates having three or more double bonds, such as glycerol tri(meth)acrylate, trimethylolpropane tri(meth)acrylate, pentaerythritol tetra(meth)acrylate and dipentaerythritol penta(meth)acrylate. The term (meth)acrylate comprises esters of the acrylic acid, the methacrylic acid, and mixtures thereof. Preferred acrylates include, for example, propanetriol triacrylate. In this case, cross-linking agents having two or more acrylate or methacrylate groups are preferred over cross-linking agents having precisely one (meth)acrylate group. Particular advantages can be achieved using methacrylic acid esters of polyvalent alcohols such as butanediol dimethacrylate.

According to one aspect of the present invention, the ratio of these cross-linking agents can be 0.01 to 10 wt %, preferably 0.03 to 5 wt %, particularly preferably 0.1 to 3 wt %, and particularly preferred is a ratio of 0.1 to 1 wt %.

According to a further embodiment, the polymerizable compound can comprise monomers containing a hydroxyl group. These include, for example, hydroxylalkyl(meth)acrylates, such as 3-hydroxypropyl(meth)acrylate, 3,4-dihydroxybutyl(meth)acrylate, 2-hydroxyethyl(meth)acrylate, and 2-hydroxypropyl(meth)acrylate. The ratio of monomers containing a hydroxyl group can preferably range from 0 to 40 wt %, particularly 0.05 to 30 wt %, particularly preferably 0.1 to 20 wt % and especially preferably from 0.5 to 5 wt %. The use of monomers containing a hydroxyl group, particularly in interaction with the polyisocyanates described further below, enables a covalent bonding of the polymethacrylate component with the polyurethane component in the cured composition. Further, the adhesion of the polymerized compound to polar substrates and inorganic construction materials can be improved. However, high ratios can increase the water absorption of the polymerized compound.

Also preferred are polymerizable compounds which comprise monomers containing an acid group. Preferred monomers containing an acid group include, particularly, acrylic acid, methacrylic acid, succinic acid-mono-(2-methacryloxy)-ethyl ester, hydroxyethyl methacrylate-phosphate (HEMA-phosphate), fumaric acid and maleic acid. The ratio of monomers containing an acid group can preferably range from 0 to 10 wt %, particularly preferably 0.1 to 5 wt % and especially preferably from 1 to 2 wt %. Monomers containing acid groups can improve the adhesion of the polymerized composition particularly to metals, such as steel, and to inorganic substrates, particularly glass. However, high ratios can undesirably increase water absorption.

Particular advantages are offered by polymerizable compounds that contain 0.03-3 wt %, or preferably ratios of 0.1-1 wt % polymerization regulators having at least 2 thiol groups in the molecule, such as ethanedithiol or pentaerythritol tetrathioglycolate.

Further, in one preferred embodiment, the polymerizable compounds contain small proportions, for example, 0.1-5 wt % a solvent-free, low-viscosity isocyanate prepolymer having a functionality ranging from 2-3.5. The functionality relates to the average number of isocyanate groups per isocyanate prepolymer molecule and can be determined volumetrically according to DIN-EN ISO 11909.

One example of an isocyanate prepolymer is Conipur 1335 from BASF. As a rule, no special urethane forming catalyst, such as dibutyltin dilaurate, is added. Instead, the redox system for radical polymerization is selected such that it consists, for example, of dibenzoyl peroxide and a tertiary aromatic amine, wherein the tertiary aromatic amine also acts as a catalyst for reaction of the diol groups of the polyurethane A with the isocyanate prepolymers.

The polymerizable compounds preferably comprise only small quantities of special urethane forming catalyst, and particularly preferably no such catalyst. Special urethane forming catalysts are characterized in that isocyanates containing hydroxyl groups are converted to at least 50% at a temperature of 25° C. within a period of 24 hours. Preferably, the content of special urethane forming catalysts is limited to a maximum of 0.02 wt %, particularly preferably a maximum of 0.001 wt %. Customary special urethane forming catalysts include particularly dibutyltin dilaurate.

The viscosity of the polymerizable compound preferably increases a maximum of 100%, preferably a maximum of 50%, particularly preferably a maximum of 20%, and most particularly preferably a maximum of 10% when stored for 10 days at 25° C. This property can particularly be achieved by the absence of special urethane forming catalysts.

Ordinarily, the polymerizable compounds are free-radically cured using initiators. Depending upon the nature of the use of the compound according to the invention, different initiator systems can be used. When impact resistant objects are produced, thermal initiators can be used. If the compounds according to the invention are used as adhesives or coating compounds, systems are preferably used which enable curing at room temperature.

Suitable thermal initiators include azo compounds, peroxy compounds, persulfate compounds and azoamidines. Non-limiting examples include dibenzoyl peroxide, dicumol peroxide, cumol hydroperoxide, diisopropyl peroxydicarbonate, bis(4-t-butylcyclohexyl)peroxydicarbonate, dipotassium persulfate, ammonium peroxydisulfate, 2,2′-azobis(2-methylpropionitrile) (AIBN), 2,2′-azobis-(isobutyric acid amidine)hydrochloride, benzopinacol, dibenzyl derivatives, methylethyl ketone peroxide, 1,1-azobiscyclohexane carbonitrile, methylethyl ketone peroxide, acetylacetone peroxide, dilauryl peroxide, didecanoyl peroxide, tert-butylperoxy-2-ethylhexanoate, ketone peroxide, methyl isobutyl ketone peroxide, cyclohexanone peroxide, tert-butylperoxy benzoate, tert-butylperoxy isopropyl carbonate, 2,5-bis(2-ethylhexanoyl-peroxy)-2,5-dimethylhexane, tert-butylperoxy-3,5,5-trimethylhexanoate, tert-butylperoxy isobutyrate, tert-butylperoxy acetate, 1,1-bis(tert-butylperoxy)cyclohexane, 1,1-bis(tert-butylperoxy)3,3,5-trimethyl cyclohexane, tert-butyl hydroperoxide, and the free-radical formers available from the DuPont company under the names ®Vazo, for example, ®Vazo V50 and ®Vazo WS. Expediently, for curing, 0.01 wt % to 15 wt %, preferably 0.1 wt % to 10 wt % and particularly preferably 0.5 wt % to 5 wt % thermal initiator referred to the weight of the polymerizable compound can be used.

Systems that enable curing at room temperature preferably comprise redox initiators or photoinitiators. Preferred photoinitiators include α,α-diethoxyacetophenone (DEAP, Upjon Corp), n-butylbenzoinether ®Trigonal-14, AKZO) and 2,2-dimethoxy-2-phenylacetophenone (®Irgacure 651) and 1-benzoylcyclohexanol (®Irgacure 184), bis(2,4,6-trimethylbenzoyl)-phenylphosphine oxide (®Irgacure 819) and 1-[4-(2-hydroxyethoxy)phenyl]-2-hydroxy-2-phenylpropan-1-one (®Irgacure 2959), each of which is available commercially from the Ciba Geigy Corp. Redox initiators can preferably comprise at least one amine compound, in addition to a free-radical former.

As a redox system, when used as a coating compound, tertiary aromatic amine and benzoyl peroxide have proven expedient, wherein this combination can be used even at low temperatures of up to −20° C. Moreover, a system of tert-butyl-mono-permaleinate (for example, 25% (approx. 0.13%))+zinc-isooctyl-thioglycolate (for example, approx. 0.05%) can advantageously be used, wherein this system is characterized by a very slight yellowing of the polymerized compounds and a uniform reaction. With continuous methods for producing plates, a rapid reaction is desirable. In this case, tert-butyl-mono-permaleinate, (for example, 25% (approx. 1.2%))+calcium hydroxide (Schaefer lime, for example, 0.3%)+pentaerythritol-tetrakis-3-mercapto-propionate (for example, approx. 0.01 to 0.15%) has proven expedient.

Of particular interest are especially curing systems which comprise at least one hydroperoxide, particularly cumyl hydroperoxide, and a p-toluenesulfonic acid halide, particularly tosyl chloride. Polymerizable compounds containing these components are characterized by high adhesion of the cured plastic to metal. This system can preferably be polymerized with an amine, for example, 3,5 diethyl-1,2-dihydro-1-phenyl-2-propylpyridine, even at very low temperatures.

The curing systems described above can be added for curing to the curable compound, for example, in the form of a solution or paste, or can be embodied as a contact curing agent. In the case of a contact curing agent, the curing composition is applied to a substrate, after which the solvent is removed by evaporation. The curable compound is then placed in contact with the dried curing composition.

Preferably, aromatic tertiary amines are used, such as dimethylaniline or di-isopropoxy-p-toluidine, for example.

Particularly when used as a coating compound, the coincident use of 0.1-5 wt %, particularly 0.2-2 wt % paraffin having a melting point ranging from 40-60° C. is advantageous.

A further aspect of the present invention are curable compositions which comprise a proportion of the above-describe polymerizable compounds and a proportion of filler materials. The polymerizable compounds are particularly well suited for producing molded bodies for use in the fields of food preparation and particularly of countertops, kitchen sinks and plumbing installations, such as shower tubs, etc. These curable compositions customarily comprise 5 to 85 wt %, preferably 20 to 80 wt %, filler materials, which are preferably inorganic in nature. The filler materials to be used are described, for example, in the documents EP 0 659 786 B2, filed on 16 Dec. 1994 with the European Patent Office under application number 94119906.9; WO 2006/048214A1, filed on 5 Apr. 2008 with the European Patent Office under application number PCT/EP2005/011627; and WO 2008/122428 A1, filed on 5 Apr. 2008 with the European Patent Office under application number PCT/EP2008/002722, wherein the described filler materials and the processing of the polymerizable compounds for producing the corresponding objects are inserted for purposes of disclosure into the present application.

Furthermore, the curable compositions can also contain other inorganic or organic filler materials, particularly reinforcement fibers made of plastics or inorganic materials, for example, glass fibers or carbon fibers. These fibers can be used in the form of a fabric.

The present invention further describes methods for producing coatings or impact-resistant objects, in which a polymerizable compound according to the invention or a curable composition according to the invention is polymerized.

Accordingly, the invention also relates to a preferred method for producing impact-resistant objects or coatings, in which a polymerizable compound, containing

A 5-30 wt % polyurethane having at least one soft segment and having a glass transition temperature of <20° C.,

B 70-95 wt % alkyl methacrylate having 1-6 carbon atoms in the alkyl group,

C 0-20 wt % one or more monomers that are copolymerizable with the alkyl methacrylates listed under B,

which is characterized in that the polyurethane A contained therein has a molecular weight ranging from 5,000-200,000 daltons and the polymerizable compound contains vinyl polymers having a molecular weight ranging from 5,000-5,000,000 daltons only in ratios of <5 wt %.,

which contains 0-3 wt %, preferably 0.03-3 wt % polymerization regulator having at least 2 thiol groups in the molecule, which contains cross-linking agents such as alkanediol di(meth)acrylate in ratios of 0-5 wt %, preferably in ratios of 0.03-1 wt %,

which contains isocyanate prepolymers having a functionality ranging from 2-3.5 in proportions of 0-5 wt %, preferably 0.1-5 wt %,

which further contains 0-5 wt %, preferably 0.1-5 wt % paraffin having a melting range of 40-60° C.,

is polymerized using a redox system comprising tertiary aromatic amine and benzoyl peroxide. In this case, the above-described redox systems can also be used.

Particularly preferred is a method in which a polymerizable compound is used, which contains polymerization inhibitor, for example, in ratios of 50-500 ppm, which delays the start of polymerization until the compound is filled up, and therefore polymerization does not occur while the components are being stirred together. Polymerization inhibitors, such as hydroquinones, hydroquinone ethers, such as hydroquinone monomethylether or di-tert-butylbrenzcatechine, phenothiazine, N,N′-(diphenyl)-p-phenylenediamine, p-phenylenediamine or sterically impeded phenols, are widely known in the field. These compounds can be used separately or in the form of mixtures, and are generally commercially available. The effect of the stabilizers consists primarily in that they act as free-radical scavengers for the free radicals occurring during polymerization. For further details, reference is made to the available literature, particularly to the Rompp Lexikon Chemie; by: J. Falbe, M. Regitz; Stuttgart, N.Y. ; 10^{th} Edition (1996); key word “antioxidants” and the passages in the literature cited therein.

In general, the components A, B and C and optionally the polymerization regulators having at least 2 thiol groups, the curing agents, the paraffin and the tertiary aromatic amine are presented as a mixture, to which the isocyanate prepolymers—if available—are added, and finally the peroxide, generally in desensitized form.

According to a preferred embodiment of the present method, the molecular weight of the polyurethane used is increased only slightly. Preferably, for example, the numerical average of the molecular weight of the polyurethane that is used increases at most by a factor of ten, particularly at most by a factor of two, preferably at most by 50%. In a preferred embodiment, the polyurethane is not cross-linked in the cured state.

### Particular Advantages of the Polymerizable Compounds According to the Invention or the Method According to the Invention

The method according to the invention results in impact-resistant molded bodies or resistant coatings (see examples). The homogeneity and transparency of the objects and coatings obtained by the method according to the invention lead one to deduce that the two polymer phases, the polyurethane and the vinyl polymer resulting from the radical polymerization, are present intimately mixed side by side. As the examples show, an improvement in resistance occurs even if the polyurethane is not cross-linked.

Because stirring is not customary during vinyl polymerization, a phase inversion presumably does not occur, even with a significant increase in the polymethacrylate phase. Under certain circumstances, the use of polyvalent thiols leads to a shortening of the polymer chains at the start of polymerization and to a lengthening of the chains at the end of polymerization, and, with the help of the cross-linking agent, to a fixing of the two-phase structure of high-molecular polyurethane and the polymethacrylate network.

In contrast, if isocyanate prepolymers are also used, an additional chain lengthening of the (hydroxy group containing) polyurethanes or the formation of polyurethane networks can also occur. Under certain circumstances, a linking of polyurethane and the polymethacrylate network also occurs by way of the polymerization regulator with 2 or more thiol groups, by the insertion of an SH group in a PMMA chain and the addition of the other thiol group to an isocyanate group with the formation of a thiourethane bond —S—CO—NH—.

The cast bodies of the present invention can be transformed via heat treatment. The use of cross-linking monomers or of the above-described isocyanate prepolymers, particularly in combination with hydroxyl group-containing monomers or polymerization regulators having 2 or more thiol groups improves this transformability at elevated temperatures. Thus, the diminishing of impact resistance can surprisingly be reduced by way of thermal treatment with the stated measures.

In addition to the described constituents, the polymerizable compounds, as listed above, can contain small proportions of polymerization inhibitors such as 2,6 di-tert-butyl-p-cresol, phenothiazine, light protection agents, mold release agents, dyes and inorganic and organic filler materials such as glass fibers or highly cross-linked polyvinyl polymers, for example, cross-linked PMMA beads having a particle diameter of 3-3,000 μm. The polymerizable compounds can further be provided with flame-proofing agents.

Furthermore, the above-described polymerizable compounds or curable compositions can contain thixotropic agents, for example, aerosils or polymers, particularly Borchigen PB 60. The ratio of thixotropic agent in the polymerizable compounds or curable compositions according to the invention can preferably range from 0 to 10 wt %, particularly preferably 0.5 to 4 wt %.

Additionally, particularly adhesion promoters may be added to the polymerizable compounds or curable compositions, wherein polyesters are preferred. Particularly preferred polyesters are commercially available under the trade name Tego® Add-bond. The proportion of adhesion promoter can preferably range from 0 to 20 wt %, particularly preferably 1 to 10 wt %.

The polymerizable compounds preferably consist of >90 wt %, preferably >98 wt %, of the above-stated components.

The polymerizable compounds according to the invention are advantageously used to produce impact-resistant objects. Of particular interest is the use of paraffin-containing compounds as coating compounds.

To particular advantage, the present polymerizable compounds can be used as adhesives and as sealing compounds, particularly for floor coatings and as joint compound.

The polymerizable resins and the curable composition can also be used in orthopedic applications. More particularly, they can be used for producing inserts for shoes.

According to one preferred embodiment, reinforcement materials, for example, non-woven fleeces or woven fabrics made of plastic, can be used in the production of seals for roofing, wherein in a first step, a polymerizable compound provided with an initiator is applied to a roof to be sealed, in a further step a flat reinforcement material, for example, a fibrous material made of polyester, is applied to the applied compound, and in a third step, an additional layer of polymerizable compound is applied to the fibrous material. This results in a laminate-type arrangement, wherein the fibrous material is bonded to the plastic material. Before the polymerizable compound is cured, the resulting coating can be pressed, in order to produce a seal and thereby achieve an effective adhesion of the polymerizable compound to the fibrous material.

The polymerizable resins and the curable composition are further suitable as a casting compound for electronic components. The above-described fiber-matrix semifinished products can be used in building boats, aircraft and automobiles.

The objects that can be obtained by curing the polymerizable compounds or the curable composition exhibit excellent mechanical properties. For instance, preferred molded bodies that are obtainable according to the present invention have an impact resistance of at least 5 kJ/m², particularly preferably at least 20 kJ/m², and most particularly preferably at least 50 kJ/m², wherein these can be measured according to DIN ISO 179/1 eU (25° C./50% relative humidity). In preferred embodiments, this high impact-resistance also decreases relatively slightly following a heat treatment of 110° C. over a period of 2 hours. Following heat treatment in the manner described above, the impact resistance of preferred molded bodies amounts to at least 5 kJ/m², particularly preferably at least 25 kJ/m², and most particularly preferably at least 45 kJ/m², measured according to the above-described conditions.

Moreover, preferred molded bodies which are provided by the present invention have a high modulus of elasticity (1 mm/min), which preferably amounts to at least 1000 MPa, particularly preferably at least 1500 MPa and most particularly preferably at least 2500 MPa, measured according to EN ISO 527 at 25° C.

Further, preferred molded bodies of the present invention are characterized by a high elongation at break and a high maximum tensile strength. Preferably, the elongation at break is at least 10%, particularly preferably at least 15%, measured according to EN ISO 527 at 25° C. The tensile strength of preferred molded bodies is at least 10 MPa, particularly preferably at least 15 MPa, measured according to EN ISO 527 at 25° C.

The following examples are intended to illustrate the invention, and are not intended as a restriction thereof.

The viscosity of the polymerizable compounds was measured according to DIN ISO 9000ff. The impact resistance of the cured samples was measured according to DIN ISO 179/1 eU.

In the following examples, all percentages are referred to weight, unless otherwise indicated.

### EXAMPLE 1

### 10% Polyurethane

| | |
|---|---|
| 100 g | polyurethane (Impranil C from Bayer), |
| 0.3 g | stabilizer (2,6-di-tert-butyl-p-cresol), |
| 1 g | ethylene glycol dithioglycolate, |
| 2 g | pentaerythritol tetrathioglycolate, |
| 5 g | butanediol-1,4-dimethyacrylate, |
| 7 g | paraffin 5205 (Fp 52-54° C.), |
| 1.5 g | tinuvin P, |
| 0.04 g | macrolex, and |
| 7 g | di-isopropxy-p-toluidine were dissolved in a total of |
| 877.7 g | methyl methacrylate and filtered. |

A homogeneous, slightly cloudy solution was obtained. The viscosity of the solution was 170 cP.

### Curing of Polymerizable Compound 1:

200 g of this polymerizable compound were mixed at room temperature with 4 g benzoyl peroxide (50% in cyclohexyl phthalate) and poured into a mold made of polyethylene.

The material was thereby cured. In this process, the temperature was increased to approx. 100° C. A transparent, approx. 4 mm thick plate was obtained. Sample specimens were cut from this plate, and the impact resistance of these sample specimens was measured:

Impact resistance at 23° C./50% relative humidity 48.3 kJ/m²

Impact resistance at −10° C.: 47.9 kJ/m².

### EXAMPLE 2

### 15% Polyurethane

The process was the same as for example 1, however 150 g Impranil C was added and accordingly, 50 g less methyl methacrylate.

A homogeneous, transparent solution was obtained. The viscosity was 1190 cP.

200 g of this polymerizable compound were mixed with benzoyl peroxide and cured, as described for example 1. The result was an approx. 4 mm thick plate.

Impact resistance at 23° C./50% relative humidity: 94.1 kJ/m²

Impact resistance at −25° C.: 48.3 kJ/m².

### EXAMPLE 3

### 10% Polyurethane, 2% Prepolymeric Isocyanate)

The process was the same as for example 1, however an additional 20 g Conipur 1335 was added, along with accordingly less methyl methacrylate.

A homogeneous, transparent solution was obtained. The viscosity was 164 cP on the first day after settling of the solution, and 209 cP on the 4^{th} day.

200 g of this polymerizable compound were mixed with 4 g benzoyl peroxide (50%) and cured, as described for example 1. The result was an approx. 4 mm thick, transparent plate.

Impact resistance at 23° C./50% relative humidity: 70.7 kJ/m²

Impact resistance at −25° C.: 36.7 kJ/m².

The plate remained homogeneous, even after heating to 110° C. Impact resistance of the heated plate at 23° C./50% relative humidity: 82.4 kJ/m².

### EXAMPLE 4

### High Concentration of Cross-Linking Agent

The process was the same as for example 1, however rather than 5 g butanediol dimethacrylate (=0.5 wt %), 60 g (=6 wt %) was chosen, along with accordingly less methyl methacrylate. A homogeneous, transparent solution was obtained. The viscosity was 173 cP.

200 g of this compound are mixed with benzoyl peroxide and cured, as described for example 1. The result is an approx. 4 mm thick plate.

Impact resistance at 23° C./50% relative humidity: 13.7 kJ/m²

Impact resistance at −25° C.: 8.7 kJ/m².

### EXAMPLE 5

### 15% Polyurethane, 1% butanediol-1,4-dimethacrylate

The process was the same as for example 2, however rather than 5 g butanediol dimethacrylate (=0.5 wt %), 10 g (=1 wt %) was chosen, along with accordingly less methyl methacrylate.

200 g of this polymerizable compound were mixed with 4 g benzoyl peroxide (50%) and cured, as described for example 1. The result was an approx. 4 mm thick, transparent plate.

Impact resistance at 23° C./50% relative humidity: 74.6 kJ/m².

The plate remained homogeneous, even after heating to 110° C. Impact resistance of the heated plate at 23° C./50% relative humidity: 64.1 kJ/m².

### EXAMPLE 6

### 10% Polyurethane, 10% butyl methacrylate

The process was the same as for example 1, however rather than adding a cross-linking agent (butanediol-1,4-dimethacrylate), 10 g butyl methacrylate was added along with accordingly less methyl methacrylate.

200 g of this polymerizable compound were mixed with 4 g benzoyl peroxide (50%) and cured, as described for example 1. The result was an approx. 4 mm thick, transparent plate.

Impact resistance at 23° C./50% relative humidity: 55.2 kJ/m²

Impact resistance at 60° C./50% relative humidity: 73.2 kJ/m².

### EXAMPLE 7

### 20% Polyurethane, No Cross-Linking Agent

| | |
|---|---|
| 200 g | polyurethane (Impranil C from Bayer), |
| 0.3 g | stabilizer (2,6-di-tert-butyl-p-cresol), |
| 7 g | paraffin 5205 (Fp 52-54° C.), |
| 7 g | di-isopropoxy-p-toluidine are dissolved in a total of |
| 85.7 g | methyl methacrylate and filtered. |

The result is a homogeneous, slightly cloudy solution.

Curing of polymerizable compound 7:

200 g of this polymerizable compound were mixed with 4 g benzoyl peroxide (50% in cyclohexyl phthalate) at room temperature, and poured into a mold made of polyethylene.

The material was thereby cured. During this process the temperature was increased to approx. 100° C. The result was a transparent, approx. 4 mm thick plate. Sample specimens were cut from this plate, and the impact resistance of these sample specimens was measured:

Impact resistance at 23° C./50% relative humidity: 113 kJ/m².

### EXAMPLE 8

### Fiber-Reinforced Plates, Particularly for Orthopedic Purposes

A resin of 8 wt % polyurethane (Impranil C) dissolved in 91 wt % methyl methacrylate was mixed with 0.4 wt % dimethyl aniline, referred to the resin weight, and 0.6 wt % dibenzoyl peroxide, referred to the resin weight. With the resulting composition, multiple layers of woven fabrics were laminated and cured between metal plates. The woven fabrics used were made of polyester. After curing, blanks can be cut to size, from which sole inserts can be produced by deformation. These shoe inserts have a high permanent elasticity.

The above-described resin was used for laminating glass fibers, carbon fibers and polyamide. The bond between carbon fibers and resin was improved by adding isocyanate, more particularly, approximately 2% an isocyanate prepolymer (Conipur 1335; BASF SE). Thereby, shoe inserts that were characterized by a high permanent elasticity were also obtained.

### EXAMPLE 9

The resin described in example 1 was rolled onto a customary methacrylate coating compound filled with silica sand and was cured. The cured seal exhibited a high permanent load bearing capacity and a high stability against weather and temperature fluctuations. The resulting seal was further characterized by low brittleness.

### EXAMPLE 10

### 21.5% Polyurethane

| | |
|---|---|
| 215 g | polyurethane (Impranil C from Bayer) |
| 0.3 g | stabilizer (2,6-di-tert-butyl-p-cresol) |
| 7 g | paraffin 5205 (Fp 52-54° C.) |
| 7 g | di-isopropoxy-p-toluidine were dissolved in a total of |
| 750.7 g | methyl methacrylate and filtered. |

The result was a homogeneous, slightly cloudy solution. The viscosity of the solution was 7750 cP.

### Curing of Polymerizable Compound 11:

200 g of this polymerizable compound were mixed with 4 g benzoyl peroxide (50% in cyclohexyl phthalate) at room temperature, and poured into a mold made of polyethylene.

The compound was thereby hardened. During the course of this process, the temperature was increased to approx. 100° C. The result was a transparent, approx. 4 mm thick plate. Sample specimens were cut from this plate, and the maximum tensile strength and elongation at break of these sample specimens were measured (ISO 527):

Maximum tensile strength at 23° C./50% relative humidity: 27.31 MPa

Elongation at break 23° C./50% relative humidity: 21.74%

### COMPARISON EXAMPLE 1

A commercial adhesive (MA 425; Plexus) was used in the manner described in example 45 to produce a sample specimen, the mechanical properties of which were investigated. The following results were obtained:

Maximum tensile strength at 23° C./50% relative humidity: 20.43 MPa

Elongation at break 23° C./50% relative humidity: 7.72%

### EXAMPLE 11

A reactive resin on the basis of (meth)acrylate was produced by mixing 77.99% methyl methacrylate, 14.5% polyurethane (Impranil® C from Bayer), 5 wt % adhesion promoter having a polyester base (TEGO Addbond LTH® from Evonik), 0.1% co-stabilizer (Alkanox® 240), 0.03 stabilizer S 18, 0.78% stabilizer (Macrolex® (0.05%)), 0.15 Tinuvin® P, 0.2% pentaerythritol tetrathioglycolate, 0.5% butanediol dimethacrylate, 0.6% di-isopropoxy-p-toluidine and 0.15% anti-foaming agent (Byk® A 515).

90 wt % reactive resin was cured with 10 wt % curing solution, which consisted of 13 wt % benzoyl peroxide (50% solution in cyclohexyl phthalate) and 87 wt % propoxy-dibenzoate (Benzoflex 2088).

The properties of the resulting adhesive were investigated in relation to various materials, wherein the results obtained are presented in Table 1.

### EXAMPLE 12

Example 11 was essentially repeated, however, thixotropic agent was added to the resin. Thus, 86 parts by weight of the reactive resin described in example 11 were mixed with 3 parts by weight Aerosil 200 and 1 part by weight Borchigen® PB60. The resulting thixotropic reactive resin was hardened with 10 parts by weight a curing solution, which consisted of 13 wt % benzoyl peroxide (50% solution in cyclohexyl phthalate) and 87 wt % propoxy-dibenzoate (Benzoflex 2088).

The properties of the obtained adhesive were investigated in relation to various materials, wherein the results obtained are presented in Table 1.

### EXAMPLE 13

Example 12 was essentially repeated, however, a different curing composition was used. 90 wt % thixotropic reactive resin according to example 12 was cured with 10 wt % a curing solution, which consisted of 13 wt % benzoyl peroxide (50% solution in cyclohexyl phthalate), 84 wt % softener (Ultramoll III), 2 wt % Aerosil and 1 wt % thixotropic agent (Borchigen PB 60).

The properties of the resulting adhesive were investigated in relation to various materials, wherein the results obtained are presented in Table 1.

### COMPARISON EXAMPLE 2

90 wt % a customary reactive resin having a methyl methacrylate base was cured with 10 wt % curing solution, which consisted of 14 wt % benzoyl peroxide (50% solution in cyclohexyl phthalate), 80 wt % methylethyl ketone (MEK) and 6 wt % acetone.

The properties of the resulting adhesive were investigated in relation to various materials, wherein the obtained results are listed in Table 1.

### COMPARISON EXAMPLE 3

A commercial adhesive having a methyl methacrylate base was used (Plexus® MA 425 from Huntsman).

The properties of the resulting adhesive were investigated in relation to various materials, wherein the obtained results are listed in Table 1. In this investigation, the curing time for the adhesive according to examples 11 to 13 was approximately 40 minutes, whereas the adhesive according to comparison example 3 required approximately 70 minutes for curing.

The materials listed in Table 1 were roughened using number 60 sandpaper, and were glued overlapping one another by approximately 1 cm². The loadability of the adhesive sites was investigated using a PCE-SH 10 k force measuring device, wherein the adhesive tensile strength was measured. If the material rather than the adhesive site was destroyed under the stress, this is noted in Table 1 by the symbol “>”. The measured tensile strengths are given in Table 1 in kg/cm².

TABLE 1
Adhesive tensile strength of adhesive sites for various materials

| | Example | Example | Example | Comparison | Comparison |
|---|---|---|---|---|---|
| | 11 | 12 | 13 | Example 2 | Example 3 |
| | [kg/cm²] | [kg/cm²] | [kg/cm²] | [kg/cm²] | [kg/cm²] |
| Aluminum | >200 | >185 | 133 | 100 | 122 |
| Copper | >400 | >400 | >424 | 280 | 207 |
| Steel | 480 | 465 | 377 | 290 | 241 |
| Stainless steel | 450 | 428 | 481 | 285 | 274 |
| Zinc plate | 500 | 489 | 305 | 210 | 186 |
| Lead | >150 | >150 | >150 | >150 | >150 |
| Particle board | >180 | >180 | >180 | >180 | >180 |
| (19 mm) | | | | | |
| Chip board | >110 | >110 | >110 | >110 | >110 |
| (10 mm) | | | | | |
| Polycarbonate | >265 | >271 | >268 | >260 | >261 |
| (PC) | | | | | |
| Polystyrene | >299 | >301 | >299 | >304 | >298 |
| (PS) | | | | | |
| Polyoxy- | 227 | 219 | 217 | 207 | 209 |
| methylene | | | | | |
| (POM) | | | | | |
| Polybutylene- | 211 | 209 | 201 | 204 | 203 |
| terephthalate | | | | | |
| (PBT) | | | | | |
| Acrylonitrile | 234 | 236 | 231 | 231 | 224 |
| butadiene- | | | | | |
| styrene | | | | | |
| copolymer | | | | | |
| (ABS) | | | | | |
| Styrene- | 226 | 208 | 204 | 194 | 196 |
| acrylonitrile | | | | | |
| (SAN) | | | | | |
| Polyvinylchloride | >304 | >308 | >317 | >310 | >299 |
| (PVC) | | | | | |
| Polypropylene | 209 | 205 | 204 | 116 | 181 |
| (PP) | | | | | |
| PET-G | 228 | 216 | 219 | 245 | 236 |
| Polyamide (PA) | >337 | >331 | >327 | 224 | 204 |
| GFK Palat | 234 | 229 | 234 | 233 | 237 |
| U570 | | | | | |
| Acrylic glass XT | >305 | >311 | >319 | >310 | >297 |
| GFK Polyester | 227 | 220 | 224 | 225 | 214 |

It is clear from the above data that polymerizable compounds according to the present invention can be used as adhesives on a multitude of very different substrates. Adhesives according to the prior art do not possess this variability, and therefore, said adhesives are highly specific to a certain material. Thus, when bonding different materials, a multitude of problems arise, which can be solved by using the polymerizable compounds of the present invention.

1. A polymerizable compound, containing
5 wt %-50 wt % polyurethane having at least one soft segment, and
30 wt %-95 wt % alkyl methacrylate having 1-6 carbon atoms in the alkyl group,
wherein the polyurethane has a molecular weight ranging from 5,000 daltons -200,000 daltons.

2. The polymerizable compound according to claim 1, wherein the polymerizable compound contains
5 wt %-30 wt % polyurethane having at least one soft segment with a glass transition temperature of <20° C.,
70 wt %-95 wt % alkyl methacrylate having 1-6 carbon atoms in the alkyl group,
0 wt %-20 wt % one or more monomers that can be copolymerized with said alkyl methacrylate, and
at least one vinyl polymer having a molecular weight ranging from 5,000 daltons -5,000,000 daltons, in a proportion of <5 wt % based on the total weight of the compound.

3. The polymerizable compound according to claim 1, wherein the polymerizable compound contains 0.03 wt %-3 wt % polymerization regulator having at least two thiol groups in the polymerization regulator molecule.

4. The polymerizable compound according to claim 1, wherein the polymerizable compound contains at least one cross-linking agent in a proportion of 0.03 wt %-5 wt % based on the total weight of the compound.

5. The polymerizable compound according to claim 1, wherein the polymerizable compound contains 0.1 wt %-5 wt % of a solvent-free, low-viscosity isocyanate prepolymer having a functionality ranging from 2-3.5.

6. The polymerizable compound according to claim 1, wherein the polymerizable compound contains a redox system for carrying out radical polymerization.

7. The polymerizable compound according to claim 1, wherein the polymerizable compound comprises a tertiary aromatic amine.

8. The polymerizable compound according to claim 1, wherein the polyurethane comprises free hydroxyl terminal groups.

9. The polymerizable compound according to claim 1, wherein the polyurethane has a viscosity ranging from 5,000 mPa·s to 200,000 mPa·s, measured according to DIN EN ISO 3219/A3 at 23° C. as a 30 percent by weight solution in ethyl acetate.

10. The polymerizable compound according to claim 1, wherein the polymerizable compound comprises no special urethane forming catalyst.

11. The polymerizable compound according to claim 1, wherein the polymerizable compound contains vinyl polymers having a molecular weight ranging from 5,000 daltons-5,000,000 daltons in a proportion of <wt % based on the total weight of the compound.

12. The polymerizable compound according to claim 1, wherein the polymerizable compound contains 0.1 wt %-5 wt % paraffin.

13. A curable composition, comprising at least one polymerizable compound according to claim 1, and at least one filler material.

14. A method for producing a coating, comprising polymerizing a polymerizable compound according to claim 1.

15. A method for producing an impact-resistant object, comprising of polymerizing a polymerizable compound according to claim 1.

16. A method for gluing objects, comprising polymerizing a polymerizable compound according to claim 1.

17. A floor coating, comprising at least one top layer obtained by polymerizing a polymerizable compound according to claim 1.

18. An impact-resistant object obtained by curing a curable composition according to claim 13.

19. The floor coating according to claim 17, wherein the polyurethane has a numerical average molecular weight ranging from 5,000 daltons to 200,000 daltons.

20. A method for producing a coating, comprising polymerizing a curable composition according to claim 13.

21. A method for producing an impact-resistant object, comprising curing a curable composition according to claim 13.

22. A floor coating, comprising at least one top layer obtained by curing a curable composition according to claim 13.
